(19) United States
(12) Patent Application Publication
(10) Pub. No.: US 2005/0029493 A1
(43) Pub. Date: Feb. 10, 2005

(54) Germicidal systems and methods therefor

(75) Inventor: Mohandas Pai, San Ramon, CA (US)

Correspondence Address: MORRISON & FOERSTER LLP, 755 PAGE MILL RD, PALO ALTO, CA, 94304-1018, US

(73) Assignee: Aquaum Corporation, San Ramon, CA (US)

(21) Appl. No.: 10/903,935

(22) Filed: Jul. 29, 2004

Related U.S. Application Data
(60) Provisional application No. 60/493,197, filed on Aug. 6, 2003.

(51) Int. Cl. A01N 1/00

(52) U.S. Cl. 252/186.1

(57) ABSTRACT

Described here are germicidal systems and methods of generating and using them. In some variations, the germicidal systems generally include an anion-exchange resin and a compound configured to non-covalently associate with the anion-exchange resin. The compound typically contains at least one donatable chlorine and at least one exchangeable anion. The compound is also typically configured to undergo resonance stabilization after the at least one donatable chlorine has been donated. Methods of generating hypochlorous acid are also described here. In general, the methods comprise the step of contacting water with a system so as to produce hypochlorous acid. The system typically comprises an anion-exchange resin, and a compound configured to non-covalently associate with the anion-exchange resin. Methods for reducing the quantity of bacteria and viruses in water are also provided here.

### CROSS-REFERENCE TO RELATED APPLICATIONS

This application claims priority to U.S. Provisional Patent Application No. 60/493,197 filed on Aug. 6, 2003, which is hereby incorporated by reference in its entirety.

### FIELD

The systems and methods described here are in the field of water disinfection, and more specifically, portable germicidal systems and methods utilizing an anion-exchange resin.

### BACKGROUND

Water filters or purifiers have been widely used to filter out certain contaminants. Most conventional water filters, however, do not provide germicidal (bacterial and viral inactivation) action, and many water disinfection liquids are unstable or ineffective. In addition, many of these filters are single units in an enclosed housing, which cannot be easily scaled up for larger disinfection tasks.

Chlorine has been used for the treatment of water for many years and its use as a disinfectant for drinking water and swimming pools is widely known. Chlorine, in its elemental form, dissolves in water to become hypochlorous acid (HClO) and hydrochloric acid (HCl). Hypochlorous acid is the moiety primarily responsible for water disinfection. Hypochlorous acid, is a weak acid, which is not harmful to people. Hydrochloric acid, while a strong acid, is not harmful to people due to the low concentration produced. The maximum residual disinfectant level for chlorine in drinking water as set forth by the EPA is 4.0 mg/L.

Chlorine is available commercially in a number of different forms, for example, chlorine gas (delivered in pressurized containers), chloroisocyanurates (e.g., sodium dichloroisocyanurate, trichloroisocyanurate, etc.), calcium hypochlorite, lithium hypochlorite, sodium hypochlorite, and the like. Sodium dichloroisocyanurate (sodium 1,3-dichloro-1,3,5-triazine-2,4-dione-6-oxide, i.e., “NaDCC”) is a particularly good source of chlorine because it does not require the addition of a stabilizing or neutralizing compound. NaDCC is an oxidizing compound that dissociates into HClO and isocyanuric acid in water. The HClO acts as the disinfecting agent, while the isocyanuric acid acts as a stabilizer. NaDCC is known to be highly efficient and to have no harm to humans.

### SUMMARY

Described here are germicidal systems and methods of generating and using them. In some variations, the germicidal systems comprise an anion-exchange resin and a compound configured to non-covalently associate with the anion-exchange resin. The compound typically comprises at least one donatable chlorine and at least one exchangeable anion. The compound is also typically configured to undergo resonance stabilization after the at least one donatable chlorine has been donated. The germicidal system may also comprise activated carbon, and/or a filter. The germicidal system may also be packaged in a porous membrane.

The germicidal system may be adapted for use in a pitcher cartridge, may be adapted for use with a faucet, or the like. In some variations, the anion-exchange resin is selected from the group consisting of a polystyrene-DVB type strong base quaternary ammonium resin, a polyacrylamide type strong base quaternary ammonium resin; a resin made of fiber derivatized with quaternary ammonium groups, a sulfonium resin, a phosphonium resin, or mixtures thereof. The compound of the germicidal system may be sodium dichloroisocyanurate, chloramine-B hydrate, 1,3-Dichloro-5,5-dimethylhydantoin, 5-Nitroorotic acid potassium salt monohydrate, and the like. In some variations, the germicidal system comprises an anion-exchange resin and chloramine-B hydrate. In some variations, the anion-exchange resin is a polystyrene-DVB type strong base quaternary ammonium resin.

Methods of generating hypochlorous acid are also described here. In general, the methods comprise the step of contacting water with a system so as to produce hypochlorous acid. The system typically comprises an anion-exchange resin, and a compound configured to non-covalently associate with the anion-exchange resin. The compound typically comprises at least one donatable chlorine and at least one exchangeable anion. The compound is typically also configured to undergo resonance stabilization after the at least one donatable chlorine has been donated. In some variations, the water that has been contacted with the system contains about 60 mg/L or less, about 50 mg/L or less, about 40 mg/L or less, about 30 mg/L or less, about 20 mg/L or less, about 10 mg/L or less, or about 4 mg/L or less of residual chlorine.

Methods for reducing the quantity of bacteria and viruses in water are also provided here. In general, these methods comprise the steps of contacting water comprising at least one bacteria or virus with a germicidal system so as to produce hypochlorous acid and contacting the at least one bacteria or virus with the hypochlorous acid. Typically, the germicidal system, comprises an anion-exchange resin, and a compound configured to non-covalently associate with the anion-exchange resin, the compound comprising at least one donatable chlorine and one exchangeable anion, and further configured to undergo resonance stabilization after the at least one donatable chlorine has been donated.

In some variations, the step of contacting the at least one bacteria or virus with the hypochlorous acid achieves about a 4 log or about a 6 log reduction in the quantity of bacteria or virus. In some variations, the water that has been contacted with the germicidal system contains about 60 mg/L or less, about 50 mg/L or less, about 40 mg/L or less, about 30 mg/L or less, about 20 mg/L or less, about 10 mg/L or less, or about 4 mg/L or less of residual chlorine.

### BRIEF DESCRIPTION OF THE DRAWINGS

FIG. 1 provides a schematic of one suitable germicidal system described here.

FIGS. 2A-2D provide illustrative compounds for use with the germicidal systems herein described.

FIG. 3 provides a schematic of how a suitable germicidal system may be prepared.

### DETAILED DESCRIPTION

Germicidal Systems

Described here are germicidal systems. In general, the germicidal systems comprise an anion-exchange resin and a compound configured to non-covalently associate with the anion-exchange resin. Typically the compound comprises at least one donatable chlorine and one exchangeable anion, and is configured to undergo resonance stabilization after the at least one donatable chlorine has been donated.

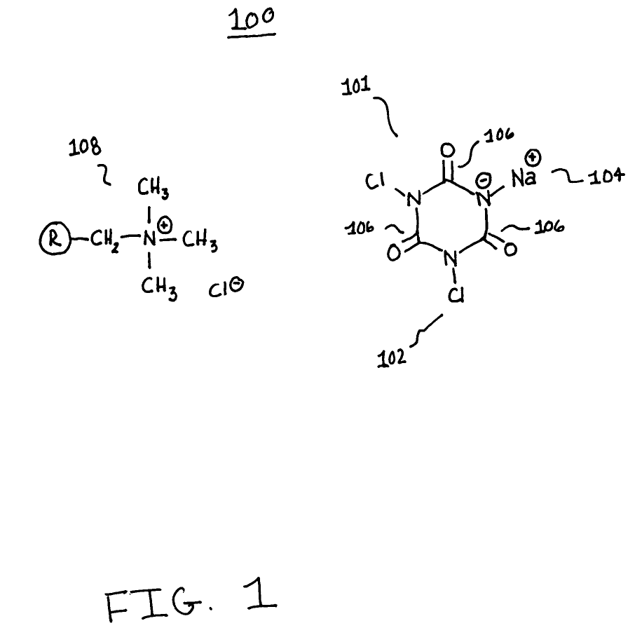

FIG. 1 provides an illustration of one such suitable germicidal system. Shown there is germicidal system (100) comprising a germicidal compound (101) and an anion-exchange resin (108). Germicidal compound (101) comprises at least one donatable chlorine (102) and one exchangeable anion (104). Germicidal compound (101) is further configured to undergo resonance stabilization via the double bond of the carbonyl groups (106) after the at least one donatable chlorine (102) has been donated.

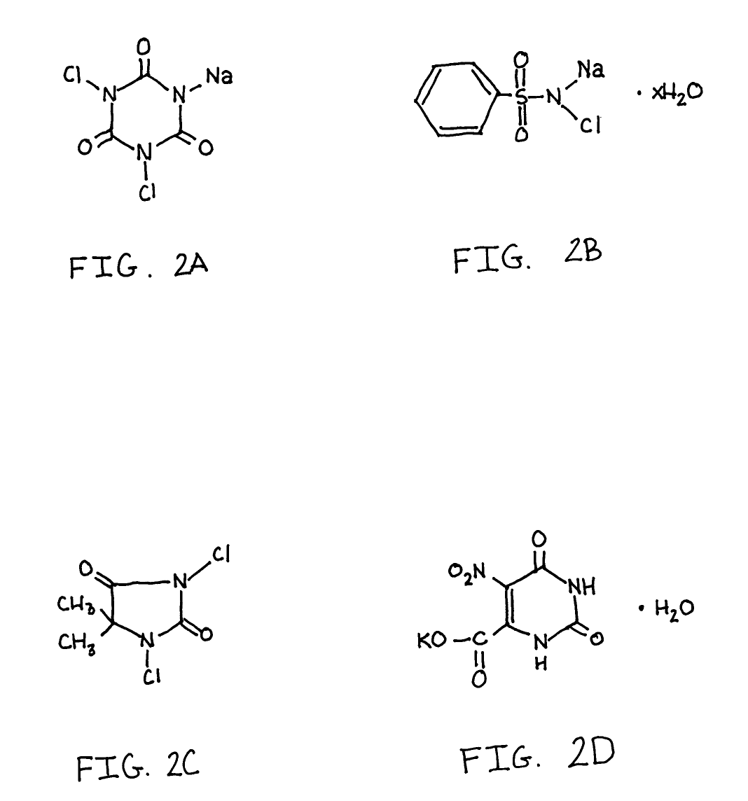

The germicidal compound may be any suitable compound that provides free chlorine. For example, the compound may be sodium dichloroisocyanurate as shown in FIG. 2A, chloramine-B hydrate as shown in FIG. 2B, 1,3-Dichloro-5,5-dimethylhydantoin as shown in FIG. 2C, 5-Nitroorotic acid potassium salt monohydrate as shown in FIG. 2D, and the like. When 1,3-Dichloro-5,5-dimethylhydantoin is to be used as the germicidal compound, it should be first converted to an ionic compound (N—Na+) so that is may be usable with the anion-exchange resin. Similarly, when 5-Nitroorotic acid potassium salt monohydrate is used, it should be first converted to an active Cl compound (N—Cl structure fragment) so that it may be usable with the anion-exchange resin. In some variations, the compound comprises chloramine-B hydrate.

The anion-exchange resin may be any suitable anion-exchange resin. For example, the anion-exchange resin may be selected from the group consisting of a polystyrene-DVB type strong base quaternary ammonium resin, a polyacrylamide type strong base quaternary ammonium resin; a resin made of fiber derivatized with quaternary ammonium groups, a sulfonium resin, a phosphonium resin, and mixtures thereof. Examples of specific anion-exchange resins that are suitable for use with the systems and methods described here include AMBERLITE® IRA-900 ION-EXCHANGE RESIN (available from SigmaAldrich Company, Product No. 216585) and AMBERLITE® IRA400(Cl), ION-EXCHANGE RESIN (available from SigmaAldrich Company, Product No. 47669). In some variations, the anion-exchange resin is a polystyrene-DVB type strong base quaternary ammonium resin. It should be understood that the anion-exchange resin need not be polymer based.

The germicidal system may also comprise activated carbon, or a filter. In this way, additional contaminants may be removed or eliminated.

The germicidal system may be packaged in any suitable way. For example, the germicidal system may be packaged in a porous membrane, and any suitable membrane may be used. In a like manner, any suitable amount of the germicidal system may be packaged within the porous membrane. In this way, an appropriate amount of the germicidal system is provided for any given application. For example, the germicidal system may be adapted for use in a pitcher cartridge, may be adapted for use with a faucet (e.g., home, public, or hospital water filtration system and the like), or may be adapted for use with sports bottles, and the like.

Methods of Use

As noted above, the germicidal systems have many suitable uses. They may be used with a faucet system (home or public) to disinfect the local water supply. Similarly, they may be used with conventional filters or cartridges for home or public water disinfection use. They may be used with sports bottles or may be adapted to fit with traditional camping canteens, and the like. Since the generation of HOCl is portable, these systems may be used in any convenient manner and in any location (e.g., when traveling to foreign countries, etc).

For example, methods of generating hypochlorous acid are described. Typically, these methods comprise the step of contacting water with a system so as to produce hypochlorous acid. The system typically comprises an anion-exchange resin, and a compound configured to non-covalently associate with the anion-exchange resin. As described above, the compound comprises at least one donatable chlorine and one exchangeable anion, and is configured to undergo resonance stabilization after the at least one donatable chlorine has been donated.

In some variations, the water that has been contacted with the system contains about 60 mg/L or less, about 50 mg/L or less, about 40 mg/L or less, about 30 mg/L or less, about 20 mg/L or less, about 10 mg/L or less, or about 4 mg/L or less of residual chlorine. The range of acceptable residual chlorine depends on the final use of the water. Typically, drinking water should have a residual chlorine level of 4 mg/L or less.

Methods for reducing the quantity of bacteria and viruses in water are also described. Typically, these methods comprise the steps of contacting water comprising at least one bacteria or virus with a germicidal system so as to produce hypochlorous acid, and contacting the at least one bacteria or virus with the hypochlorous acid. Typically, the germicidal system comprises an anion-exchange resin, and a compound configured to non-covalently associate with the anion-exchange resin. The compound typically comprises at least one donatable chlorine and one exchangeable anion, and is configured to undergo resonance stabilization after the at least one donatable chlorine has been donated. In some variations, the step of contacting the at least one bacteria or virus with the hypochlorous acid achieves about a 4 log reduction in the quantity of bacteria or virus. In other variations, the step of contacting the at least one bacteria or virus with the hypochlorous acid achieves about a 6 log reduction in the quantity of bacteria or virus.

In some variations, the water that has been contacted with the system contains about 60 mg/L or less, about 50 mg/L or less, about 40 mg/L or less, about 30 mg/L or less, about 20 mg/L or less, about 10 mg/L or less, or about 4 mg/L or less of residual chlorine. The range of acceptable residual chlorine depends on the final use of the water. As noted above, the range of acceptable residual chlorine depends on the final use of the water. Typically, drinking water should have a residual chlorine level of 4 mg/L or less.

Methods of Preparation

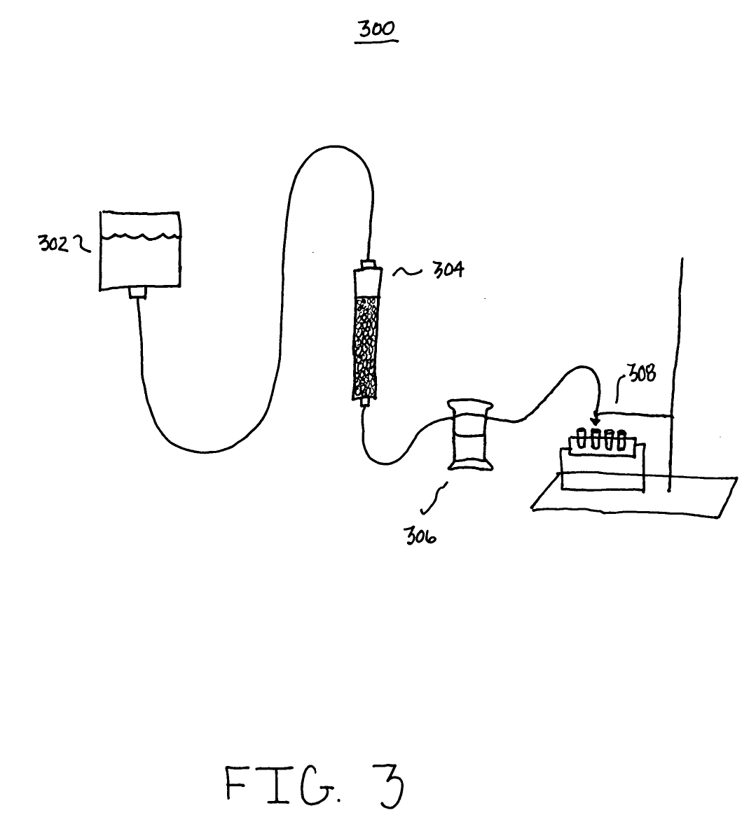

Any suitable method of preparing the germicidal systems may be used. Shown in FIG. 3 is one such suitable method (300). Shown there is solution reservoir (302) connected to a resin column (304). Connected to the resin column (304) is peristaltic pump (306), which connects to fraction collector (308). While a resin column (304) is depicted, it should be understood that a membrane filter, or other suitable filter or column may be used.

The germicidal solution is pumped through the resin filled column for a suitable length of time, and then the column is washed and dried. For example, one suitable method of preparing a germicidal system when the germicidal compound is NaDCC is as follows. First, a 10% solution (0.45M) of NaDCC is prepared in distilled water (e.g., by dissolving 250 gm of NaDCC in 2.5 liters of distilled water). Then, a sutiable ion-exchange resin is placed in the resin column (e.g., 60 ml of AMBERLITE® IRA-900 ION-EXCHANGE RESIN). The NaDCC solution is pumped through the resin filled column for a suitable time at a suitable flowrate (e.g., 20 hours at 2 ml/minute). Distilled water is then pumped through the resin column for a suitable time at a suitable flowrate (e.g., 4 hours at 20 ml/minute). Chlorine ions in the anion-exchange resin are replaced by dichloroisocyanurate ion to result in the production of a germicidal system. The germicidal system is then dried (e.g., using a paper towel, or air dried overnight). A suitable amount of dry germicidal system is then weighed and placed in a mesh bag or other porous membrane, for example, and sealed. The bag can then be placed in any suitable container, e.g., filters, faucet heads, or even pen barrels. Water is then poured through the bag to achieve HOCl generation as described above.

Spent resins and/or membranes may be regenerated by passing a saturated solution of sodium chloride through the resin and/or membrane until there is no longer any cyanurate moiety in the eluent. The chloride form is converted to the germicidal form in the system using a solution having a germicidal compound (e.g., NaDCC) as described above.

### EXAMPLES

MS-2 Coliphage ATCC 15597B-1 and E. coli ATCC 11229 were spiked into two 1 gallon test water units. The seed concentration for MS-2 and E. coli were approximately 105 per mL. The characteristics of the two test water samples are provided below. After approximately 1 liter of seeded water passed through each of three test filters, an initial sample was taken. Another sample was taken was taken after approximately 3 liters passed through the unit, and then again after 4 liters had passed. The total volume of test water passed through each of the filters was 4 L. Total residual chlorine was measured in a sub-sample of each test sample and the total time for the passage of fluid through the test filters was recorded. The numbers of bacteria or coliphage in the samples were recorded and the log reduction in numbers calculated.

TABLE 1
Characteristics of Test Water Samples

| Water | | | | | | | Temp. |
|---|---|---|---|---|---|---|---|
| Type | pH | TOC | | TDS | | NTU | ° C. |
| Test | 6.5-8.8 | 0.1-5.0 | mg/L | 50-500 | mg/L | <0.5 | 20 ± 5 |
| Water 1 | | | | | | | |
| Test | 9 ± 0.5 | >10 | mg/L | 1500 ± 150 | mg/L | ≧30 | 4 ± 1 |
| Water 2 | | | | | | | |

TABLE 2
Total Residual Chlorine and Time for the Sample Volumes to be Produced

| Test | Liter Sample | RX1-01 | RX1-02 | RX1-03 |
|---|---|---|---|---|
| Total | 1 | 2.4 | >5.5 | 2.3 |
| Chlorine | 3 | 2.2. | 9.6 | 63.7 |
| (mg/L) | 4 | 2.4 | 10.1 | — |
| Filter Time | 1 | 6.3 | 3.7 | 9.1 |
| (min.) | 3 | 17.4 | 11.8 | 55.3 |
| Cummulative | 4 | 23.5 | 16.3 | — |

TABLE 3
MS2 Coliphage Challenge Results

| Test Unit | Liter Sample | Pfu/mL | Log Reduction |
|---|---|---|---|
| RX1-01 | Influent | 1.3 × 10⁶ | 0 |
| | 1 | <1 | >6.1 |
| | 3 | <1 | >6.1 |
| | 4 | <1 | >6.1 |
| RX1-02 | Influent | 1.3 × 10⁶ | 0 |
| | 1 | <1 | >6.1 |
| | 3 | <1 | >6.1 |
| | 4 | <1 | >6.1 |
| RX1-03 | Influent | 8.7 × 10⁵ | 0 |
| | 1 | <1 | >5.9 |
| | 2.3 | <1 | >5.9 |

TABLE 4
E. Coli Challenge Results

| Test Unit | Liter Sample | Cfu/100 mL | Log Reduction |
|---|---|---|---|
| RX1-01 | Influent | 1.3 × 10⁶ | 0 |
| | 1 | <1 | >6.1 |
| | 3 | <1 | >6.1 |
| | 4 | <1 | >6.1 |
| RX1-02 | Influent | 1.3 × 10⁶ | 0 |
| | 1 | <1 | >6.1 |
| | 3 | <1 | >6.1 |
| | 4 | <1 | >6.1 |
| RX1-03 | Influent | 8.9 × 10⁵ | 0 |
| | 1 | <1 | >6.0 |
| | 2.3 | <1 | >6.0 |

RX1-02 were challenged with Test Water 1 described above, while RX1-03 with Test Water 2.

It should be understood that the applications of the germicidal system and methods of use described herein are not limited. Indeed, they may include any number of further applications. Modifications of the above-described systems and methods, and variations of the same will be apparent to those of skill in the art and intended to be within the scope of the

1. A germicidal system comprising:
an anion-exchange resin; and
a compound configured to non-covalently associate with the anion-exchange resin, the compound comprising at least one donatable chlorine and one exchangeable anion, and further configured to undergo resonance stabilization after the at least one donatable chlorine has been donated.

2. The germicidal system of claim 1 further comprising activated carbon.

3. The germicidal system of claim 1 packaged in a porous membrane.

4. The germicidal system of claim 1 further comprising a filter.

5. The germicidal system of claim 1 adapted for use in a pitcher cartridge.

6. The germicidal system of claim 1 adapted for use with a faucet.

7. The germicidal system of claim 1 wherein the anion-exchange resin is selected from the group consisting of a polystyrene-DVB type strong base quaternary ammonium resin, a polyacrylamide type strong base quaternary ammonium resin; a resin made of fiber derivatized with quaternary ammonium groups, a sulfonium resin, a phosphonium resin, and mixtures thereof.

8. The germicidal system of claim 1 wherein the compound is sodium dichloroisocyanurate.

9. The germicidal system of claim 1 wherein the compound is chloramine-B hydrate.

10. The germicidal system of claim 1 wherein the compound is 1,3-Dichloro-5,5-dimethylhydantoin.

11. The germicidal system of claim 1 wherein the compound is 5-Nitroorotic acid potassium salt monohydrate.

12. A germicidal system comprising:
an anion-exchange resin; and
chloramine-B hydrate.

13. The germicidal system of claim 12 wherein the anion-exchange resin is selected from the group consisting of a polystyrene-DVB type strong base quaternary ammonium resin, a polyacrylamide type strong base quaternary ammonium resin; a resin made of fiber derivatized with quaternary ammonium groups, a sulfonium resin, a phosphonium resin, and mixtures thereof.

14. The germicidal system of claim 13 wherein the anion-exchange resin is a polystyrene-DVB type strong base quaternary ammonium resin.

15. The germicidal system of claim 12 further comprising activated carbon.

16. The germicidal system of claim 12 packaged in a porous membrane.

17. The germicidal system of claim 12 further comprising a filter.

18. The germicidal system of claim 12 adapted for use in a pitcher cartridge.

19. The germicidal system of claim 12 adapted for use with a faucet.

20. A method of generating hypochlorous acid comprising the step of:
contacting water with a system so as to produce hypochlorous acid wherein the system comprises
an anion-exchange resin, and
a compound configured to non-covalently associate with the anion-exchange resin, the compound comprising at least one donatable chlorine and one exchangeable anion, and further configured to undergo resonance stabilization after the at least one donatable chlorine has been donated.

21. The method of claim 20 wherein the water that has been contacted with the system contains less than about 60 mg/L of residual chlorine.

22. The method of claim 20 wherein the water that has been contacted with the system contains less than about 50 mg/L of residual chlorine.

23. The method of claim 20 wherein the water that has been contacted with the system contains less than about 40 mg/L of residual chlorine.

24. The method of claim 20 wherein the water that has been contacted with the system contains less than about 30 mg/L of residual chlorine.

25. The method.of claim 20 wherein the water that has been contacted with the system contains less than about 20 mg/L of residual chlorine.

26. The method of claim 20 wherein the water that has been contacted with the system contains less than about 10 mg/L of residual chlorine.

27. The method of claim 20 wherein the water that has been contacted with the system contains less than about 4 mg/L of residual chlorine.

28. A method for reducing the quantity of bacteria and viruses in water comprising the steps of:
contacting water comprising at least one bacteria or virus with a germicidal system so as to produce hypochlorous acid, wherein the germicidal system, comprises
an anion-exchange resin, and
a compound configured to non-covalently associate with the anion-exchange resin, the compound comprising at least one donatable chlorine and one exchangeable anion, and further configured to undergo resonance stabilization after the at least one donatable chlorine has been donated; and
contacting the at least one bacteria or virus with the hypochlorous acid.

29. The method of claim 28 wherein the step of contacting the at least one bacteria or virus with the hypochlorous acid achieves about a 4 log reduction in the quantity of bacteria or virus.

30. The method of claim 28 wherein the step of contacting the at least one bacteria or virus with the hypochlorous acid achieves about a 6 log reduction in the quantity of bacteria or virus.

31. The method of claim 28 wherein the water that has been contacted with the germicidal system contains less than about 60 mg/L of residual chlorine.

32. The method of claim 28 wherein the water that has been contacted with the germicidal system contains less than about 50 mg/L of residual chlorine.

33. The method of claim 28 wherein the water that has been contacted with the germicidal system contains less than about 40 mg/L of residual chlorine.

34. The method of claim 28 wherein the water that has been contacted with the germicidal system contains less than about 30 mg/L of residual chlorine.

35. The method of claim 28 wherein the water that has been contacted with the germicidal system contains less than about 20 mg/L of residual chlorine.

36. The method of claim 28 wherein the water that has been contacted with the germicidal system contains less than about 10 mg/L of residual chlorine.

37. The method of claim 28 wherein the water that has been contacted with the germicidal system contains less than about 4 mg/L of residual chlorine.
